(19) United States
(12) Patent Application Publication
(10) Pub. No.: US 2016/0063633 A1
(43) Pub. Date: Mar. 3, 2016

(54) USER INTERFACE FOR REAL ESTATE DEVELOPMENT AND COMMUNICATIONS PLATFORM

(71) Applicants: Ian Ross, Oakland, CA (US); Tomas Janusas, Oakland, CA (US); Stephan Orme, Oakland, CA (US)

(72) Inventors: Ian Ross, Oakland, CA (US); Tomas Janusas, Oakland, CA (US); Stephan Orme, Oakland, CA (US)

(21) Appl. No.: 14/843,177

(22) Filed: Sep. 2, 2015

Related U.S. Application Data
(60) Provisional application No. 62/044,763, filed on Sep. 2, 2014.

(51) Int. Cl. G06Q 40/06; G06Q 50/16; G06Q 40/00; G06F 17/30; G06F 3/0481

(52) U.S. Cl. CPC G06Q 40/06; G06F 17/30241; G06F 3/04815; G06Q 40/10; G06Q 50/163

(57) ABSTRACT

In some embodiments, a method to generate a visualization of real estate development data may include receiving, at a communications module, source data from third party servers; inferring, at a data module, inferred location attributes from the source data; analyzing, at an analytics module, development opportunities and building potential of a selected property based on the inferred location attributes; analyzing, at the analytics module, zoning regulations and tax records of the selected property based on inferences made by the data module; calculating, at the analytics module, economic and tax potential of development capacity of a specified property; and/or creating, at a visualization module, a 3D representation of the development opportunities and building potential to display on a 3D map, based on the inferences made by the data module, as well as the calculations made by the analytics module.

### CROSS REFERENCE TO RELATED APPLICATIONS

This application claims the benefit of priority to U.S. Provisional Application Ser. No. 62/044,763, filed Sep. 2, 2014, the contents of which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014, OppSites, Inc. All Rights Reserved.

### TECHNICAL FIELD

Embodiments of the present disclosure relate generally to computer technology, real-estate, and more particularly, but not by way of limitation, to a technology platform and user interfaces economic development and government communications.

### BACKGROUND

Data processing systems can be programmed to facilitate analysis of a wide array of data items. In turn, this analysis may ultimately lead to innovative applications which have practical real-world applications. An example of such data items may include geographic data, economic data, and planning data. The current approach to use such data may be through the creation of large, cumbersome spreadsheets, and non-standardized documentation which must then be analyzed deeper to gain any valuable information. This approach is burdensome and cannot efficiently keep up with the speed in which data is now gathered, and further does not provide the flexibility that the analysis of such data may require

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating a building and development potential analytics system, according to some example embodiments.

FIG. 3 is a flow diagram illustrating an example method for calculating building and development potential, economic potential, and tax potential of a property from the attribute source data.

FIG. 4 depicts various example attribute sources, according to some example embodiments.

FIGS. 5-13 depict example user's interfaces in accordance with example embodiments.

FIG. 14 is a block diagram illustrating a software architecture that may be installed on a machine, according to some example embodiments.

FIG. 15 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example embodiments provide systems and methods for communicating geographic, planning, and economic data that can be used to inform public and private sector analysis of real estate development opportunities and analysis of impacts from policy changes. More specifically, real estate professionals assess unrealized building, economic, and investment potential, while municipalities may analyze physical and economic impacts of changes to zoning policies. In accordance with the example embodiments, a variety of sources for data are combined to provide an analytic model for the user. For example, relevant data is gathered from a variety of sources, pertaining to geography, planning, and economic data, which may include, but is not limited to: building height, floor-to-area ratios, residential density, permitted land uses. This data is then reorganized to create a standardized set of database tables. These datatables are then used to create key values for each parcel including, but not limited to: development potential, building potential, and tax revenue. In further example embodiments, the data may be used to create or generate a visualization such as a colored polygon rendered to appear above user-selected parcels. The visualization may indicate or illustrate permitted height of new buildings. In some example embodiments, the visualization may be overlaid with a Three Dimensional (3D) building map to create a comparative environment of the delta between existing buildings and development potential. In another example embodiment, the data may be used to estimate development capacity. For example, through analysis of geographic data and planning data, a visual model can be created depicting the number of potential dwelling units for residential, and square feet of non-residential use. In yet another example embodiment, the generated models of building and development potential may be combined with existing local economic factors to present an evaluation of economic opportunities for potential investors.

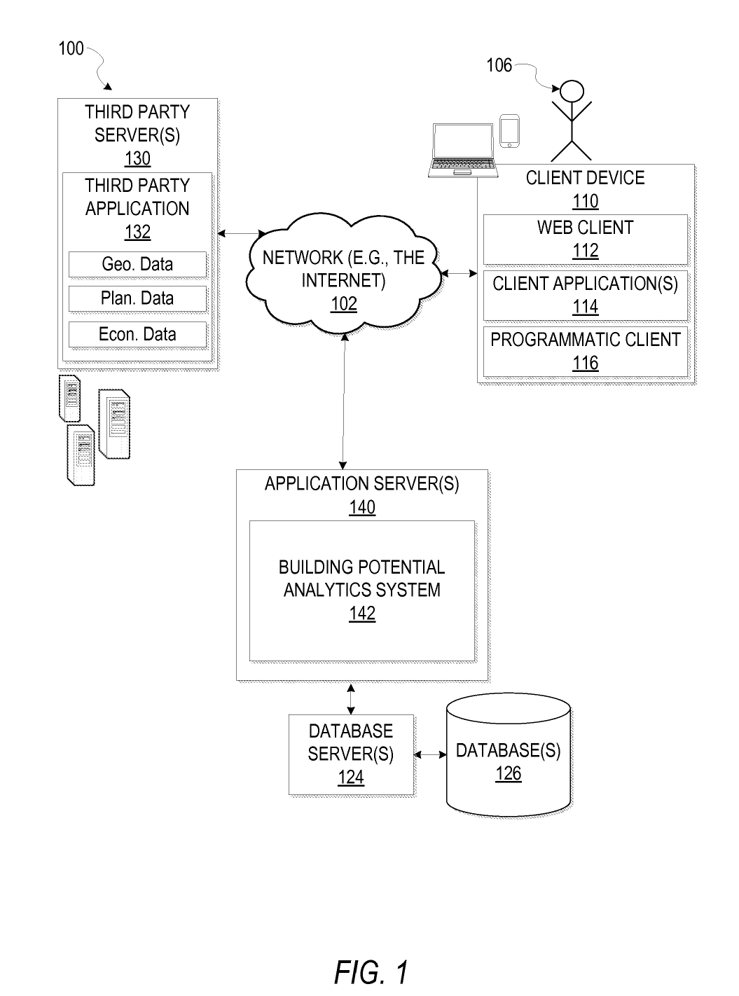

With reference to FIG. 1, an example embodiment of a high-level client-server-based network architecture 100 is shown. A network 102 provides server-side functionality to a client device 110. In some implementations, a user (e.g., user 106) interacts with the networked system 102 using the client device 110. FIG. 1 illustrates, for example, a web client 112 (e.g., a browser, such as the Internet Explorer® browser developed by Microsoft® Corporation of Redmond, Washington State), client application(s) 114, and a programmatic client 116 executing on the client device 110. The client device 110 may include the web client 112, the client application(s) 114, and the programmatic client 116 alone, together, or in any suitable combination. Although FIG. 1 shows one client device 110, in other implementations, the network architecture 100 comprises multiple client devices.

The client device 110 may comprise a computing device that includes at least a display and communication capabilities that provide access to the network 102. The client device 110 may comprise, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 102 via a wired or wireless connection. For example, one or more portions of the network 102 comprises an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMax) network, another type of network, or any suitable combination thereof.

In some example embodiments, the client device 110 may include one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, and e-commerce site apps (also referred to as “marketplace apps”). In some implementations, the client application(s) 114 include various components operable to present information to the user and communicate with network 102. In some embodiments, if the e-commerce site application is included in the client device 110, then this application may be configured to locally provide the user interface and at least some of the functionalities with the application configured to communicate with the network 102, on an as needed basis, for data or processing capabilities not locally available (e.g., access to a database of items available for sale, to authenticate a user, to verify a method of payment). Conversely, if the e-commerce site application is not included in the client device 110, the client device 110 can use its web browser to access the e-commerce site (or a variant thereof) hosted on the network 102.

In various example embodiments, the user (e.g., the user 106) comprises a person, a machine, or other means of interacting with the client device 110. In some example embodiments, the user is not be part of the network architecture 100, but interacts with the network architecture 100 via the client device 110 or another means. For instance, the user provides input (e.g., touch screen input or alphanumeric input) to the client device 110 and the input is communicated to the network 102. The user can interact with the networked system 102 using the client device 110. Additionally, a third party application 132, executing on a third party server 130, is shown as having programmatic access to the network 102.

Further, while the client-server-based network architecture 100 shown in FIG. 1 employs a client-server architecture, the present inventive subject matter is, of course, not limited to such an architecture, and may equally well find application in a distributed, or peer-to-peer, architecture system, for example. The systems of the applications server(s) 140 (e.g., the building and development potential analytics system(s) 142) may also be implemented as standalone software programs, which do not necessarily have networking capabilities.

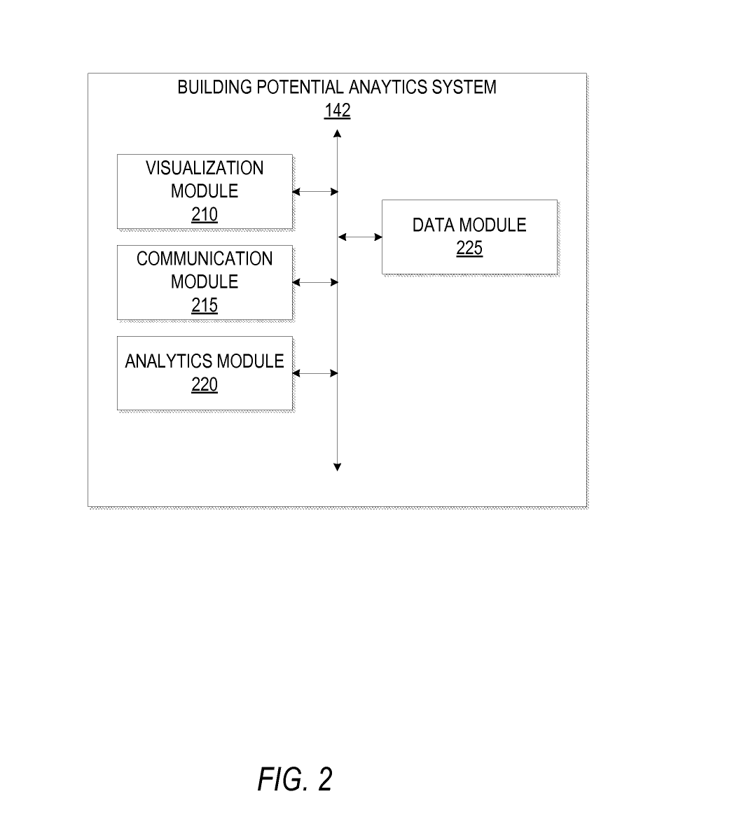

FIG. 2 is a block diagram depicting an example building and development (also change to fig title) potential analytics system 142 that may provide functionality operable to perform various analytics using data. In an example embodiment, the building and development potential analytics system 142 may include visualization module 210, a communication module 215, an analytics module 220, and a data module 225. All, or some, of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

Visualization module 210 may provide various visualization functionality, operable to interactively present 3D visuals to communicate geographic, planning, and economic data that can, in some embodiments, be used to inform private sector analysis of real estate development opportunities and public sector analysis of impacts from/of policy changes. Information may be presented to the user by visualization module 210 in the form of colored polygons above user-selected parcels to create a comparative environment of the delta between existing buildings and development potential.

Communication module 215 may perform various network communication functions, such as communicating with network 104, the database servers 124, and the third party servers 130. Network communication may operate over any wired or wireless means to provide communication functionality.

Analytics module 220 may perform various analytic functions on available data. In some embodiments, the analytics module 220 may calculate location attributes such as building and development potential, economic potential, and tax potential.

Data module 225 may perform various data functions. In some embodiments, data module 225 may take diverse source data and reorganize it by creating abstractions by which it may produce data sets. For example, data module 225 may create abstractions of geographic locations which contain one or more parcel records, parameter-based zoning rules for locations, geographic-region based zoning rules for locations, point-to-object based zoning rules for locations, and zoning exception rules for locations.

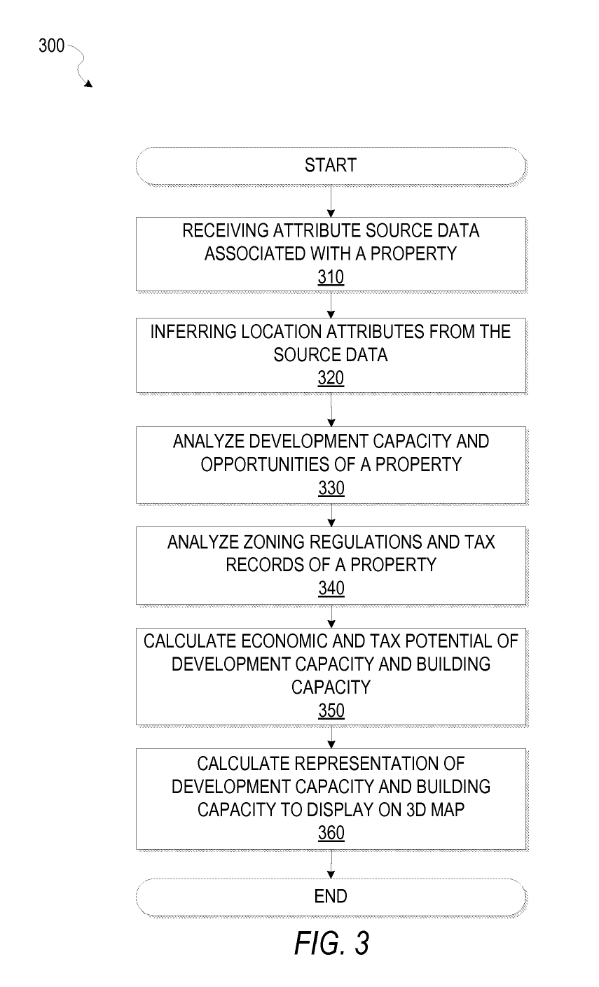

FIG. 3 is a flow diagram illustrating at a high level an example method 300 for analyzing development opportunities, and zoning and planning policies. The method 300 is merely a non-limiting example of a method for analyzing development opportunities, and zoning and planning policies. At operation 310, the communication module 215 may receive data from third party servers 130. The data may include a wide variety of data from many different sources. For example, the data may be geographic data including, but not limited to street maps, 3D building maps, parcel maps, zoning maps, along with any other relevant geographic data.

At operation 320, the data module 225 infers location attributes from the source data. In various example embodiments, each location attribute corresponds to a particular physical geographic location. In some embodiments, this may include property floor-to-area-ratios, density minimum and maximums, height minimum and maximums, private property records, valuations, as well as information corresponding to an environment of a particular geographic location.

At operation 330, the analytics module 220 analyzes the development opportunities and building potential of a selected property based on inferences made by the data module 225. For example, the analytics module 220 may combine unrealized building and development potential with local economic factors to evaluate economic opportunities for investors, or use geographic data and planning data to estimate development capacity of a given site.

At operation 340, the analytics module 220 analyzes zoning regulations and tax records of a selected property based on inferences made by the data module 225. For example, the analytics module 220 may forecast future tax and revenue associated with future development, or allow city officials, stakeholders, and community members to view impacts to the built environment per changes to development regulations.

At operation 350, the analytics module 220 calculates economic and tax potential of development capacity of a specified property. For example, this may be achieved based on analysis completed at operations 330 and 340.

At operation 360, the visualization module 210, creates a 3D representation of building and development potential to display on a 3D map, based on the inferences made by the data module 225, as well as the calculations made by the analytics module 220. In some embodiments, the 3D model may be in the form of colored polygons rendered to appear above user-selected parcels to create a comparative environment of the delta between existing buildings and development potential.

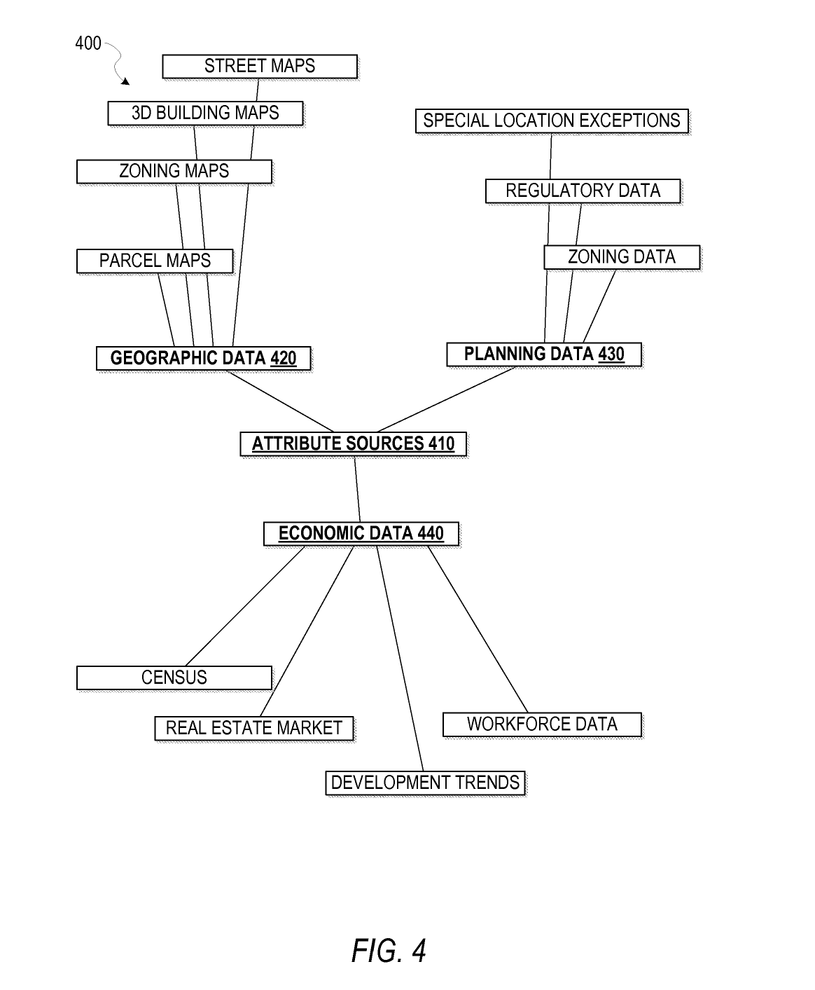

FIG. 4 is a diagram 400 that depicts examples of various attribute sources 410. In some embodiments, attribute sources 410 may be collected from geographic data 420, planning data 430, and economic data 440. For example: geographic data 420 may be sourced from street maps, 3D building maps, zoning maps, or parcel data; planning data 430 may be sourced from zoning data, regulatory data, or special location exceptions; and economic data 440 may be sourced from a census, a real estate market, development trends, or workforce data.

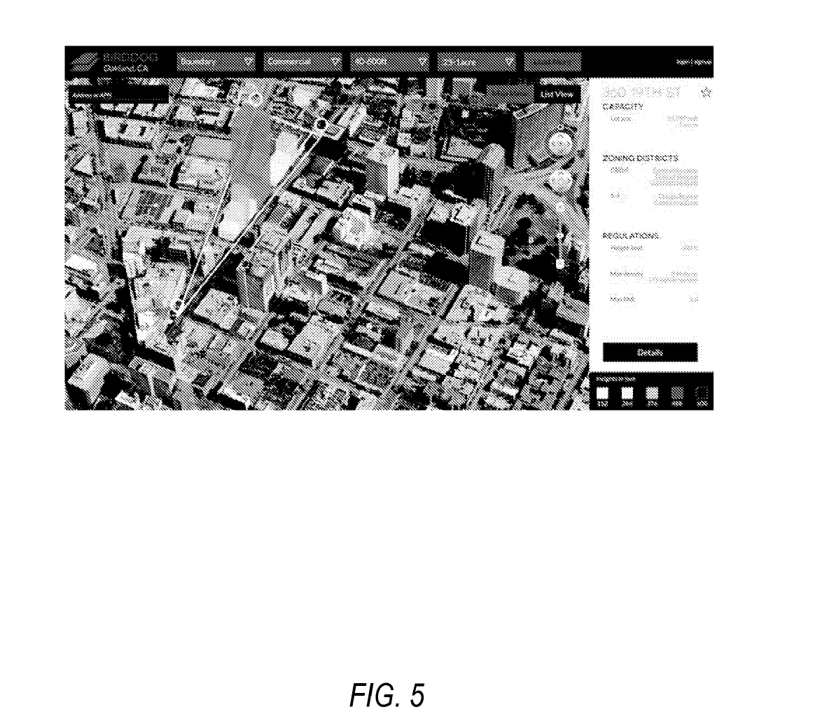

FIG. 5 depicts an example user interface for analyzing development opportunities, and zoning and planning policies. In an example embodiment, the user may select districts or parcels on a 2D map to summon a 3D rendering of planning data. For example, when the user selects a specific location, the visualization module 210 may project the analysis done by the analytics module 220 into a 3D space which the user may manipulate and view in real-time. In another example embodiment, the user may draw an arbitrary boundary onto the 2D map to query all parcels within the boundary.

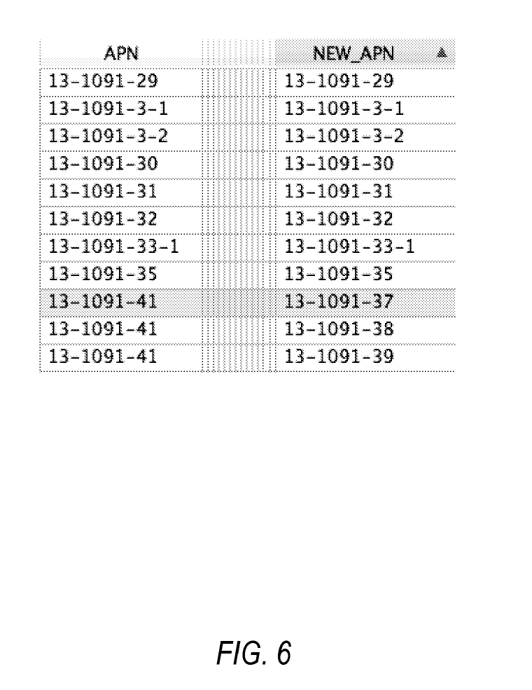

FIG. 6 depicts an example embodiment of database architecture when a specified geographic boundary has multiple Assessor Parcel Numbers, or APN, the analytics module 220 may define the boundary as a “location” and associate it with all parcels assigned to it. This is later used for analyzing development opportunities, and zoning and planning policies for the particular “location” and the associated parcels that fall within.

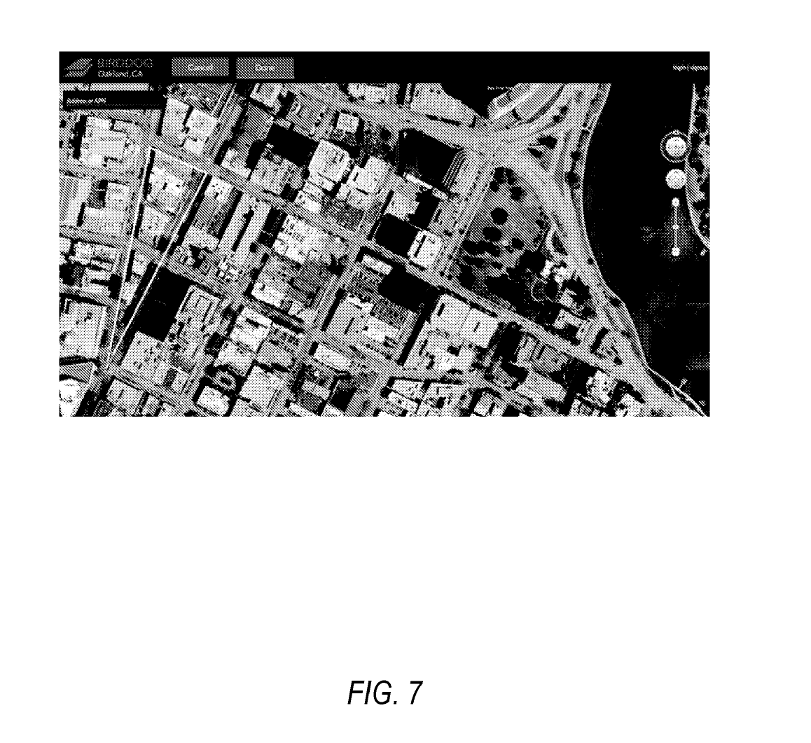

FIG. 7 depicts an example user interface for analyzing development opportunities, and zoning and planning policies. In one example embodiment, the user may draw an arbitrary boundary on the map to query all parcels within the boundary. For example, the visualization module 210 may allow a user to select intersections of streets to determine the boundary for a desired parcel. In some embodiments, this may be accomplished by either placing points or lines directly onto a map, manually entering an address, manually entering specific search criteria, or automatically selecting a parcel through a GPS.

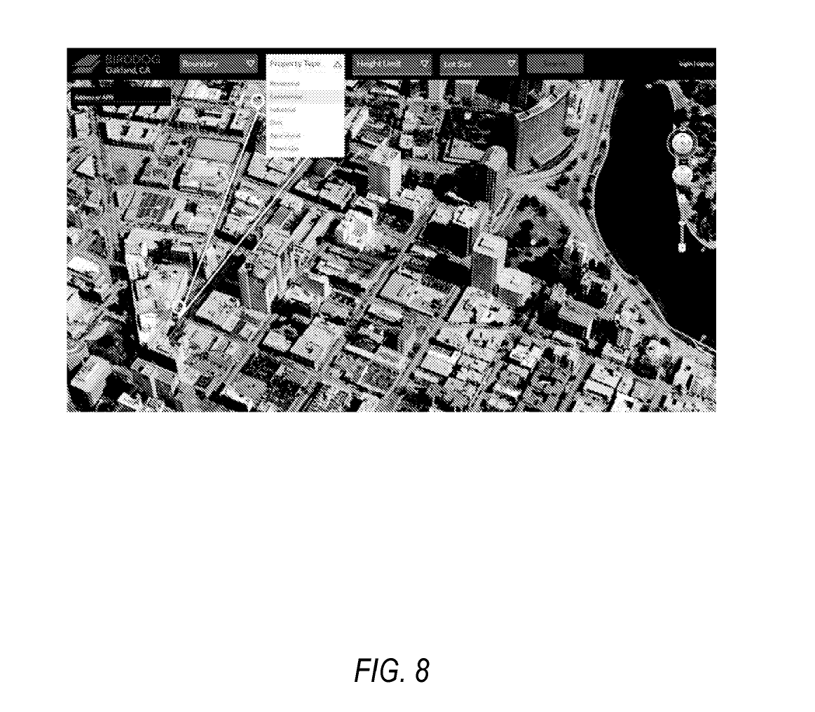

FIG. 8 depicts an example user interface for analyzing development opportunities, and zoning and planning policies. In some example embodiments, a user may select a parcel through selected data provided by the data module 225. This list of search criteria may include, but is not limited to: land use type or category; height limit; lot size; address; or boundary. For example, a user may specify the boundary to focus the search, and the type of property they are searching for. A 3D view may then be presented to the user by the visualization module 210.

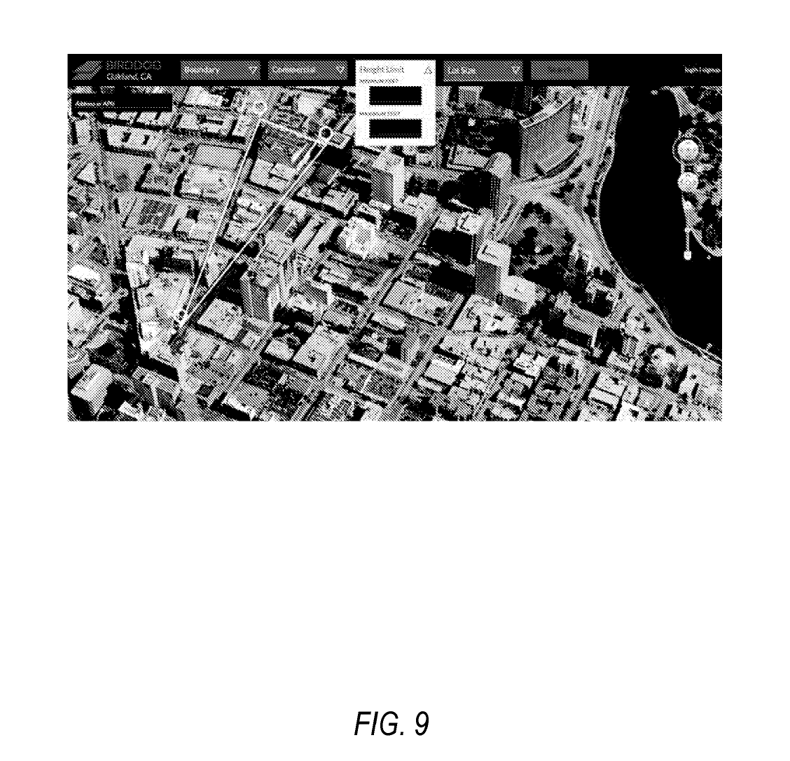

FIG. 9 depicts an example user interface for analyzing development opportunities, and zoning and planning policies. In some example embodiments, a user may select a parcel through selected data provided by the data module 225. This list of search criteria may include, but is not limited to: development and land use type or category; height limit; lot size; or boundary.

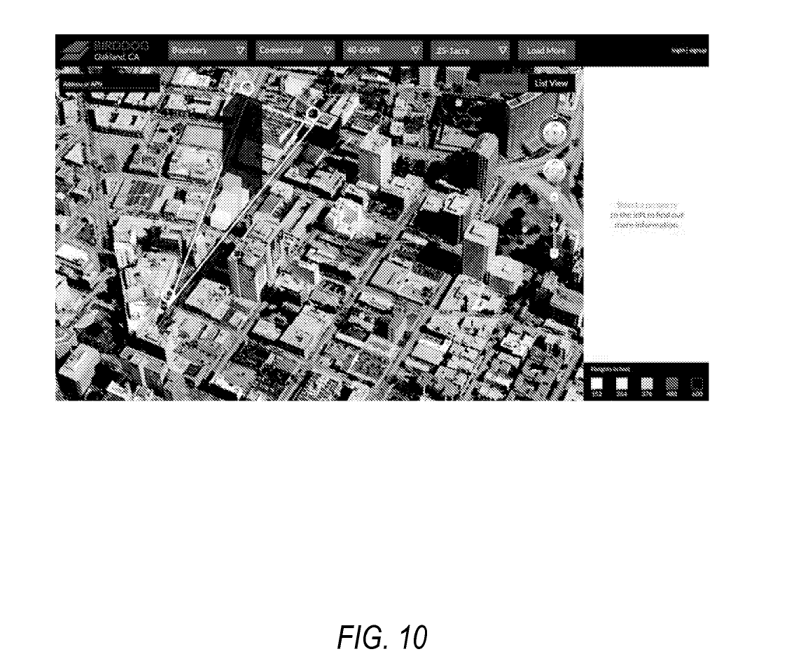

FIG. 10 depicts an example user interface for analyzing development opportunities, and zoning and planning policies. In some example embodiments, the user may select a parcel through selected data provided by the data module 225. This list of search criteria may include, but is not limited to: land use type; height limit; lot size; address; or boundary. For example, once the user has selected their desired criteria, the visualization module 210 may present a 3D model of the building and development potential onto a map environment.

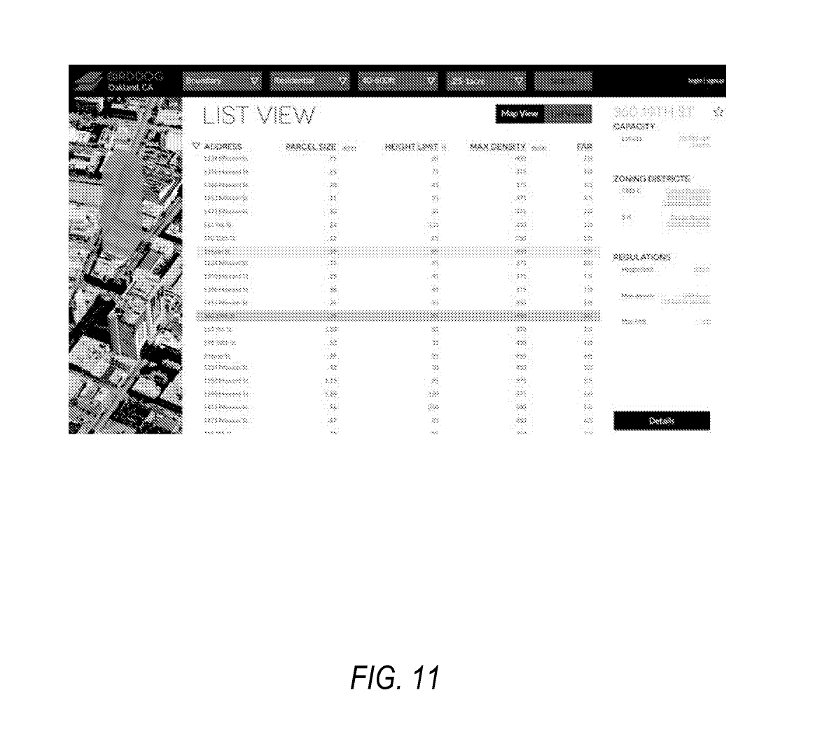

FIG. 11 depicts an example user interface for analyzing development opportunities, and zoning and planning policies for opportunities. In some example embodiments, a user may select a parcel through selected data provided by the data module 225. This list of search criteria may include, but is not limited to: land use type; height limit; lot size; address; or boundary. For example, once the user has selected their desired criteria, the visualization module 210 may present a 3D model of the building and development potential onto a map environment. In another example embodiment, the user may then view the available data collected by the data module 225. For example, a user may view a list of all data associated with all parcels within a selected boundary including, but not limited to, address, parcel size, land uses, height limit, minimum and maximum density, as well as zoning restrictions and regulations.

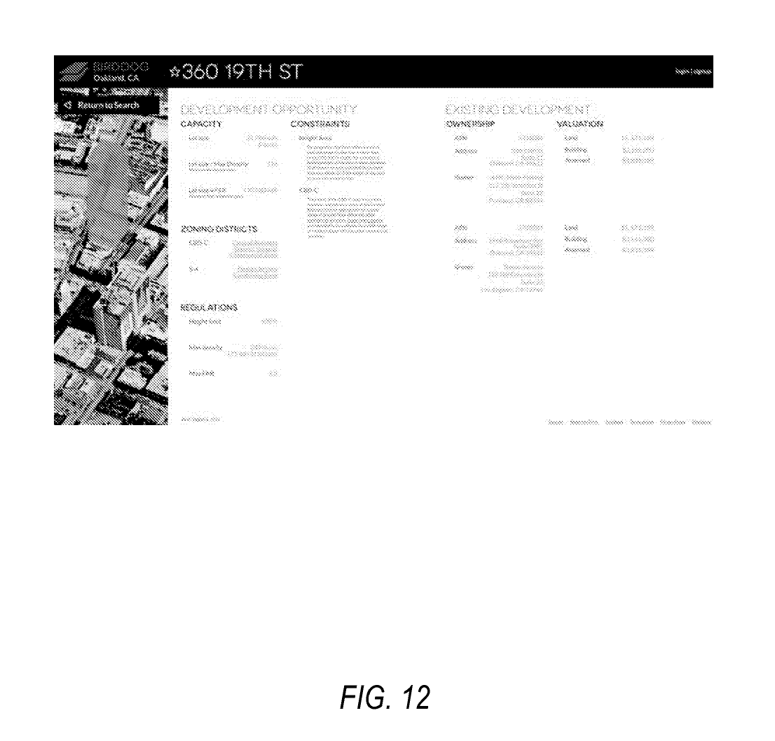

FIG. 12 depicts an example user interface for analyzing development opportunities, and zoning and planning policies. In some example embodiments, the user may select a particular parcel based on data provided by the data module 225. This list of search criteria may include, but is not limited to: property type; height limit; lot size; address; or boundary. For example, once the user has selected their desired criteria, the visualization module 210 may present a 3D model of the building and development potential onto a map environment. In another example embodiment, the user may then view the analysis done by the analytics module 220. For example, this may include a summary of development opportunity, constraints, and what the existing development is.

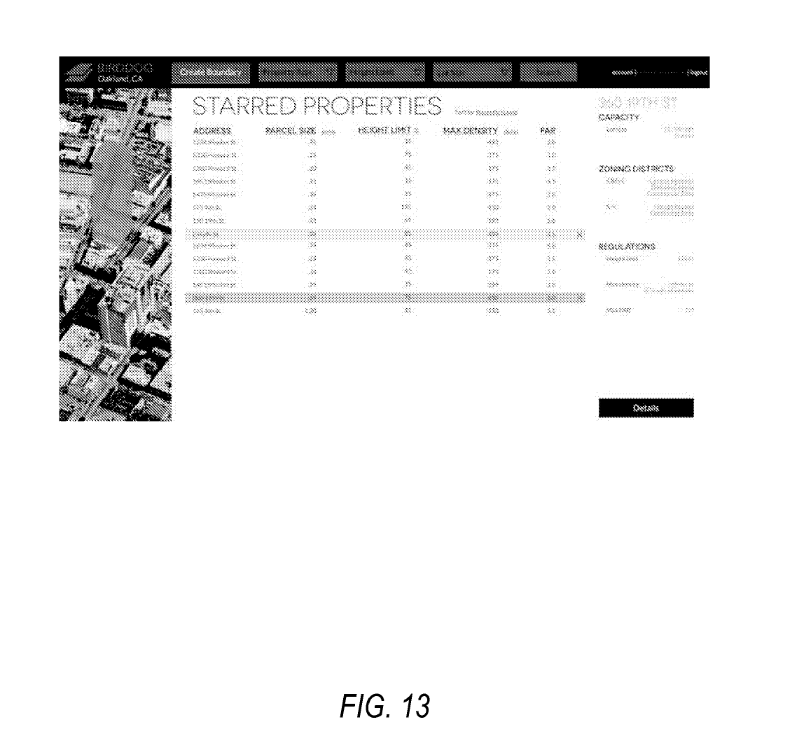

FIG. 13 depicts an example user interface for analyzing development opportunities, and zoning and planning policies. In some example embodiments, a user may select a parcel through selected data provided by the data module 225. This list of search criteria may include, but is not limited to: property type; height limit; lot size; address; or boundary. For example, once the user has selected their desired criteria, the visualization module 210 may present a 3D model of the building and development potential onto a map environment. In another example embodiment, the user may then view the available data collected by the data module 225, and view only a select few, which are then presented to the user by the visualization module 210.

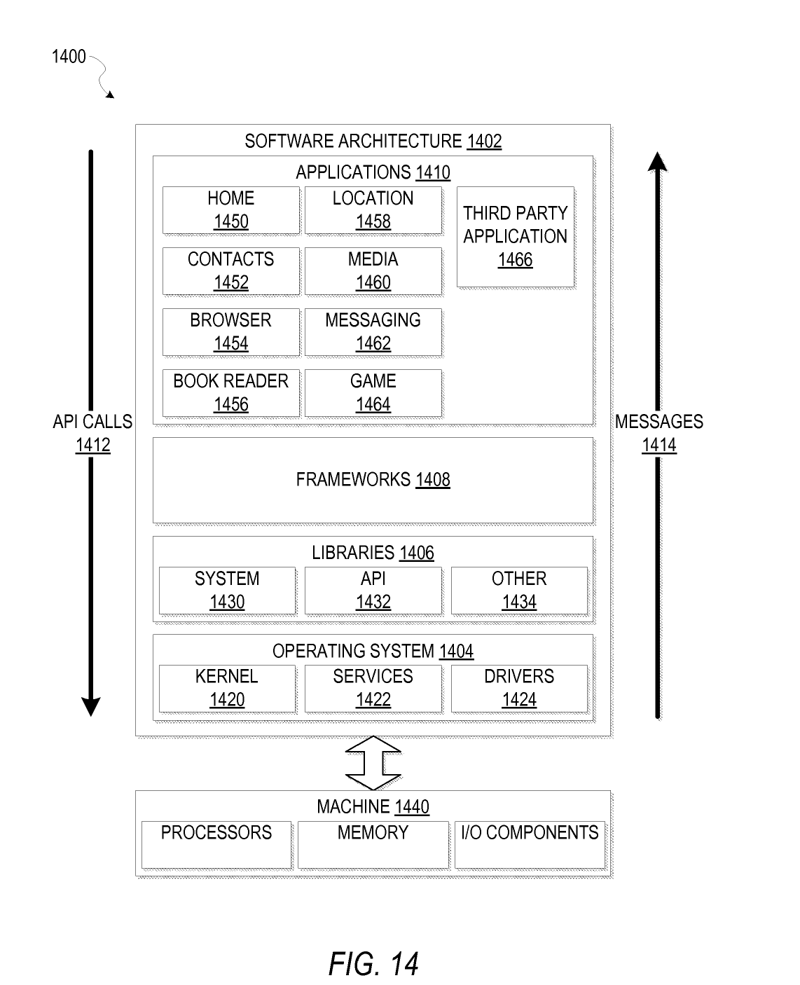

FIG. 14 is a block diagram 1400 illustrating an architecture of software 1402, which may be installed on any one or more of devices described above. FIG. 14 is merely a non-limiting example of a software architecture, and it will be appreciated that many other architectures may be implemented to facilitate the functionality described herein. The software 1402 may be executing on hardware such as machine 1440 that includes processors, memory, and I/O components. In the example architecture of FIG. 14, the software 1402 may be conceptualized as a stack of layers where each layer may provide particular functionality. For example, the software 1402 may include layers such as an operating system 1404, libraries 1406, frameworks 1408, and applications 1410. Operationally, the applications 1410 may invoke application programming interface (API) calls 1412 through the software stack and receive messages 1414 in response to the API calls 1412.

The operating system 1404 may manage hardware resources and provide common services. The operating system 1404 may include, for example, a kernel 1420, services 1422, and drivers 1424. The kernel 1420 may act as an abstraction layer between the hardware and the other software layers. For example, the kernel 1420 may be responsible for memory management, processor management (e.g., scheduling), component management, networking, security settings, and so on. The services 1422 may provide other common services for the other software layers. The drivers 1424 may be responsible for controlling or interfacing with the underlying hardware. For instance, the drivers 1424 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 1406 may provide a low-level common infrastructure that may be utilized by the applications 1410. The libraries 1406 may include system 1430 libraries (e.g., C standard library) that may provide functions such as memory allocation functions, string manipulation functions, mathematic functions, and the like. In addition, the libraries 1406 may include API libraries 1432 such as media libraries (e.g., libraries to support presentation and manipulation of various media formats such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1406 may also include a wide variety of other libraries 1434 to provide many other APIs to the applications 1410.

The frameworks 1408 may provide a high-level common infrastructure that may be utilized by the applications 1410. For example, the frameworks 1408 may provide various graphic user interface (GUI) functions, high-level resource management, high-level location services, and so forth. The frameworks 1408 may provide a broad spectrum of other APIs that may be utilized by the applications 1410, some of which may be specific to a particular operating system or platform.

The applications 1410 include a home application 1450, a contacts application 1452, a browser application 1454, a book reader application 1456, a location application 1458, a media application 1460, a messaging application 1462, a game application 1464, and a broad assortment of other applications such as third party application 1466. In a specific example, the third party application 1466 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1466 may invoke the API calls 1412 provided by the mobile operating system 1404 to facilitate functionality described herein.

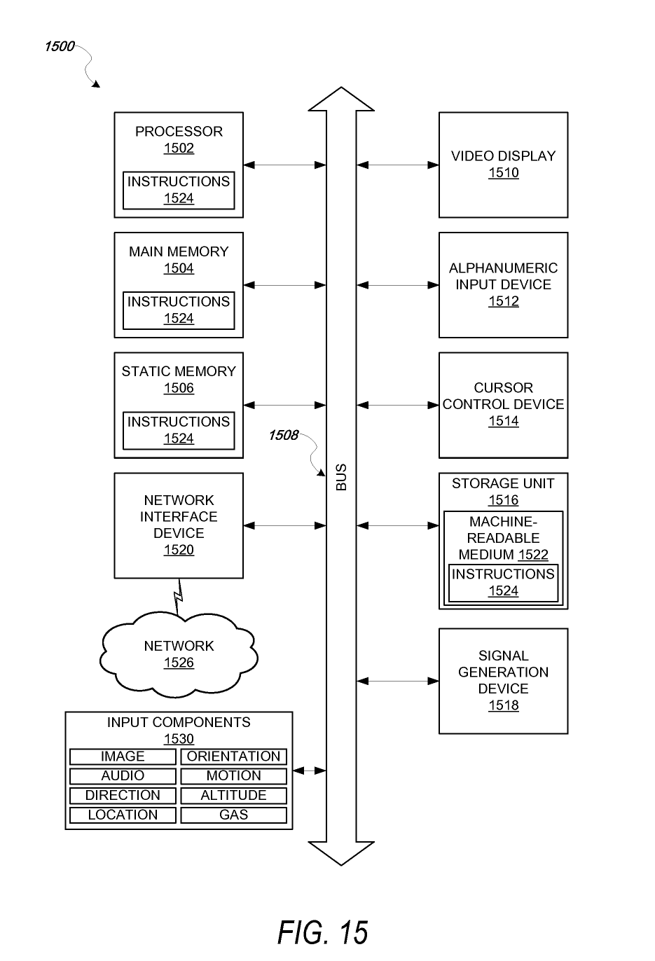

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1524 (e.g., software, a program, an application, an applet, an app, or other executable code) for causing the machine 1500 to perform any one or more of the methodologies discussed herein may be executed. In alternative embodiments, the machine 1500 operates as a standalone device or may be connected (e.g., networked) to other machines. In a networked deployment, the machine 1500 may operate in the capacity of a server machine or a client machine in a server-client network environment, or as a peer machine in a peer-to-peer (or distributed) network environment. The machine 1500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1524, sequentially or otherwise, that specify actions to be taken by that machine. Further, while only a single machine 1500 is illustrated, the term “machine” shall also be taken to include a collection of machines 1500 that individually or jointly execute the instructions 1524 to perform any one or more of the methodologies discussed herein.

The machine 1500 includes a processor 1502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1504, and a static memory 1506, which are configured to communicate with each other via a bus 1508. The machine 1500 may further include a video display 1510 (e.g., a plasma display panel (PDP), a light emitting diode (LED) display, a liquid crystal display (LCD), a projector, or a cathode ray tube (CRT)). The machine 1500 may also include an alphanumeric input device 1512 (e.g., a keyboard), a cursor control device 1514 (e.g., a mouse, a touchpad, a trackball, a joystick, a motion sensor, or other pointing instrument), a storage unit 1516, a signal generation device 1518 (e.g., a speaker), and a network interface device 1520.

The storage unit 1516 includes a machine-readable medium 1522 on which is stored the instructions 1524 embodying any one or more of the methodologies or functions described herein. The instructions 1524 may also reside, completely or at least partially, within the main memory 1504, within the static memory 1506, within the processor 1502 (e.g., within the processor's cache memory), or both, during execution thereof by the machine 1500. Accordingly, the main memory 1504, static memory 1506 and the processor 1502 may be considered as machine-readable media 1522. The instructions 1524 may be transmitted or received over a network 1526 via the network interface device 1520.

In some example embodiments, the machine 1500 may be a portable computing device, such as a smart phone or tablet computer, and have one or more additional input components 1530 (e.g., sensors or gauges). Examples of such input components 1530 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1522 able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e.g., a centralized or distributed database, or associated caches and servers) able to store instructions 1524. The term “machine-readable medium” shall also be taken to include any medium, or combination of multiple media, that is capable of storing instructions (e.g., instruction 1524) for execution by a machine (e.g., machine 1500), such that the instructions, when executed by one or more processors of the machine 1500 (e.g., processor 1502), cause the machine 1500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 1522 is non-transitory in that it does not embody a propagating signal. However, labeling the machine-readable medium 1522 as “non-transitory” should not be construed to mean that the medium is incapable of movement; the medium should be considered as being transportable from one physical location to another. Additionally, since the machine-readable medium 1522 is tangible, the medium may be considered to be a machine-readable device.

The instructions 1524 may further be transmitted or received over a communications network 1526 using a transmission medium via the network interface device 1520 and utilizing any one of a number of well-known transfer protocols (e.g., hypertext transfer protocol (HTTP)). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 1524 for execution by the machine 1500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 1522 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 1502, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1502 that are temporarily configured (e.g., by software) or permanently configured to perform the relevant operations. Whether temporarily or permanently configured, such processors 1502 may constitute processor-implemented modules that operate to perform one or more operations or functions described herein. As used herein, “processor-implemented module” refers to a hardware module implemented using one or more processors 1502.

Similarly, the methods described herein may be at least partially processor-implemented, with a processor 1502 being an example of hardware. For example, at least some of the operations of a method may be performed by one or more processors 1502 or processor-implemented modules. Moreover, the one or more processors 1502 may also operate to support performance of the relevant operations in a “cloud computing” environment or as a “software as a service” (SaaS). For example, at least some of the operations may be performed by a group of computers (as examples of machines 1500 including processors 1502), with these operations being accessible via the network 1526 (e.g., the Internet) and via one or more appropriate interfaces (e.g., an application program interface (API)).

The performance of certain of the operations may be distributed among the one or more processors 1502, not only residing within a single machine 1500, but deployed across a number of machines 1500. In some example embodiments, the one or more processors 1502 or processor-implemented modules may be located in a single geographic location (e.g., within a home environment, an office environment, or a server farm). In other example embodiments, the one or more processors 1502 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method to generate a visualization of real estate development data, the method comprising:
receiving, at a communications module, source data from third party servers;
inferring, at a data module, inferred location attributes from the source data;
analyzing, at an analytics module, development opportunities and building potential of a selected property based on the inferred location attributes;
analyzing, at the analytics module, zoning regulations and tax records of the selected property based on inferences made by the data module;
calculating, at the analytics module, economic and tax potential of development capacity of a specified property; and
creating, at a visualization module, a 3D representation of the development opportunities and building potential to display on a 3D map, based on the inferences made by the data module, as well as the calculations made by the analytics module.

2. The method of claim 1, wherein the source data comprises geographic data including at least one of 3D building maps, parcel maps, and zoning maps.

3. The method of claim 1, wherein the source data comprise planning data including at least one of zoning data, regulatory data, and special location exceptions.

4. The method of claim 1, wherein the source data comprise economic data including at least one of census data, real estate market data, development trend data, and workforce data.

5. The method of claim 1, wherein the inferred location attributes attribute corresponds to a particular physical geographic location.

6. The method of claim 1, wherein the inferred location attributes comprises at lest one of property floor-to-area-ratios, density minimum and maximums, height minimum and maximums, private property records, valuations, and information corresponding to an environment of a particular geographic location.

7. The method of claim 1, wherein the analyzing of the development opportunities and building potential comprises combining unrealized building and development potential with local economic factors to evaluate economic opportunities for investors.

8. The method of claim 1, wherein the analyzing of the development opportunities and building potential comprise use of geographic data and planning data to estimate development capacity of a given site.

9. The method of claim 1, wherein the analyzing, at the analytics module, of the zoning regulations and the tax records of the selected property comprise forecasting future tax and revenue associated with future development.

10. The method of claim 1, wherein the analyzing, at the analytics module, of the zoning regulations and the tax records of the selected property comprise generating and presenting a graphical user interface that allows city officials, stakeholders, and community members to view impacts to a built environment per changes to development regulations.

11. The method of claim 1, wherein the 3D representation includes colored polygons rendered to appear above user-selected parcels to create a comparative environment of a delta between existing buildings and development potential.

12. A server, the server comprising:
a processor; and
a memory storing instructions that, when executed by the processor, configure the server to:
receive, at a processor-implemented communications module, source data from third party servers;
infer, at a processor-implemented data module, inferred location attributes from the source data;
analyze, at a processor-implemented analytics module, development opportunities and building potential of a selected property based on the inferred location attributes;
analyze, at a processor-implemented analytics module, zoning regulations and tax records of the selected property based on inferences made by the data module;
calculate, at the analytics module, economic and tax potential of development capacity of a specified property; and
create, at a processor-implemented visualization module, a 3D representation of the development opportunities and building potential to display on a 3D map, based on the inferences made by the data module, as well as the calculations made by the analytics module.

13. The server of claim 12, wherein the inferred location attributes comprises at lest one of property floor-to-area-ratios, density minimum and maximums, height minimum and maximums, private property records, valuations, and information corresponding to an environment of a particular geographic location.

14. The server of claim 12, wherein the analyzing of the development opportunities and building potential comprises combine unrealized building and development potential with local economic factors to evaluate economic opportunities for investors.

15. The server of claim 12, wherein the analyzing of the development opportunities and building potential comprise use of geographic data and plan data to estimate development capacity of a given site.

16. The server of claim 12, wherein the analyzing, at the analytics module, of the zoning regulations and the tax records of the selected property comprise forecast future tax and revenue associated with future development.

17. The server of claim 12, wherein the analyzing, at the analytics module, of the zoning regulations and the tax records of the selected property comprise generate and presenting a graphical user interface that allows city officials, stakeholders, and community members to view impacts to a built environment per changes to development regulations.

18. The server of claim 12, wherein the 3D representation includes colored polygons rendered to appear above user-selected parcels to create a comparative environment of a delta between existing buildings and development potential.

19. A non-transitory computer-readable storage medium, the computer-readable storage medium including instructions that when executed by a computer, cause the computer to:
receive, at a communications module, source data from third party servers;
infer, at a data module, inferred location attributes from the source data;
analyzing, at an analytics module, development opportunities and building potential of a selected property based on the inferred location attributes;
analyzing, at the analytics module, zoning regulations and tax records of the selected property based on inferences made by the data module;
calculate, at the analytics module, economic and tax potential of development capacity of a specified property; and
create, at a visualization module, a 3D representation of the development opportunities and building potential to display on a 3D map, based on the inferences made by the data module, as well as the calculations made by the analytics module.
